(19) United States
(12) Patent Application Publication
(10) Pub. No.: US 2025/0022380 A1
(43) Pub. Date: Jan. 16, 2025

(54) IN-FLIGHT MANEUVER DETECTION

(71) Applicant: THE BOEING COMPANY, Arlington, VA (US)

(72) Inventors: Alejandro GÜEMES JIMÉNEZ, Getafe (ES); Robin C. DREWS, Darmstadt (DE); Marko ZORICIC, Dreieich (DE)

(21) Appl. No.: 18/351,427

(22) Filed: Jul. 12, 2023

(51) Int. Cl. G08G 5/00; G08G 5/04

(52) U.S. Cl. CPC G08G 5/0078; G08G 5/0039; G08G 5/04

(57) ABSTRACT

Aspects of the present disclosure provide systems and methods for in-flight go-around maneuver detection. An example method includes monitoring information associated with a flight path of a first aircraft while the first aircraft is flying. The method further includes detecting a maneuver associated with the flight path in response to one or more criteria associated with the monitored information being satisfied. The method further includes performing one or more actions associated with the second aircraft in response to detecting the maneuver.

### FIELD

The present disclosure relates to vehicle analytics. More particularly, the present disclosure relates to in-flight detection of a maneuver associated with a flight path of an aircraft.

### BACKGROUND

Airline flight operations are a complex decision-making process subject to several factors. Weather, maintenance, utilization, airport rules, crew and passenger connections, and pre-flight tasks (like fueling, cargo handling, and provisioning) are among the many factors that can affect airline operations. A go-around maneuver, also known as a missed approach, is a type of flight maneuver performed by an aircraft, for example, when the aircraft is unable to land safely on the runway during an approach. A go-around maneuver may occur due to a variety of reasons, such as runway occupancy, weather conditions, or other operational considerations. During a go-around maneuver, the pilot may abort a landing and perform a climb, typically to a holding pattern or to another airport. Go-around maneuvers are a component of flight safety, and are performed to ensure that the aircraft remains in controlled airspace and are able to make a safe landing even if conditions at the intended destination are not favorable.

### SUMMARY

Some aspects provide a method. The method includes monitoring information associated with a flight path of a first aircraft while the first aircraft is flying. The method further includes detecting a maneuver associated with the flight path in response to one or more criteria associated with the monitored information being satisfied. The method further includes performing one or more actions associated with a second aircraft in response to detecting the maneuver.

Some aspects provide an apparatus. The apparatus includes a memory. The apparatus includes one or more processors coupled to the memory. The one or more processors are configured to monitor information associated with a flight path of a first aircraft while the first aircraft is flying, detect a maneuver associated with the flight path in response to one or more criteria associated with the monitored information being satisfied, and perform one or more actions associated with one more second aircraft in response to detecting the maneuver.

Some aspects provide a non-transitory computer-readable medium storing code that, when executed by one or more processors of an apparatus, cause the apparatus to perform a method. The method includes monitoring information associated with a flight path of a first aircraft while the first aircraft is flying. The method further includes detecting a maneuver associated with the flight path in response to one or more criteria associated with the monitored information being satisfied. The method further includes performing one or more actions associated with one more second aircraft in response to detecting the maneuver.

### BRIEF DESCRIPTION OF THE DRAWINGS

So that the manner in which the above recited features can be understood in detail, a more particular description, briefly summarized above, may be had by reference to example embodiments, some of which are illustrated in the appended drawings.

FIG. 1 is a diagram illustrating an example system that detects a maneuver of an aircraft.

FIG. 2 is a diagram illustrating example operations for in-flight detection of a maneuver.

FIGS. 3A and 3B illustrate an example speed and altitude graph over time and a flight path associated with a flight in which a go-around maneuver is detected.

FIG. 4 illustrates an example go-around maneuver being detected when an aircraft departs from and arrives at the same airport.

FIG. 5 illustrates a speed and altitude graph over time of an example flight, where the height above the destination is used to detect a go-around maneuver.

FIG. 6 illustrates an example speed and altitude graph over time where multiple go-around maneuvers are detected

FIG. 7 is a method flow diagram illustrating example operations for in-flight detection of a maneuver.

### DETAILED DESCRIPTION

Aspects of the present disclosure provide apparatus, methods, processing systems, and computer-readable mediums for in-flight go-around maneuver detection.

There are several data sources that provide information related to characteristics of a go-around maneuver. Some data sources that can be used to detect a go-around maneuver may include, for example, ground-based radar, automatic dependent surveillance-broadcast (ADS-B), flight data monitoring (FDM), flight management system (FMS), and/or ground-based augmentation system (GBAS) may. However, all these data sources use a human to analyze the information and infer the occurrence of a go-around maneuver. Such human-based detection of a go-around maneuver may cause delays in responding to (e.g., due to in-flight confirmation with the aircraft crew and/or various distractions) and/or cause a missed detection of a go-around maneuver.

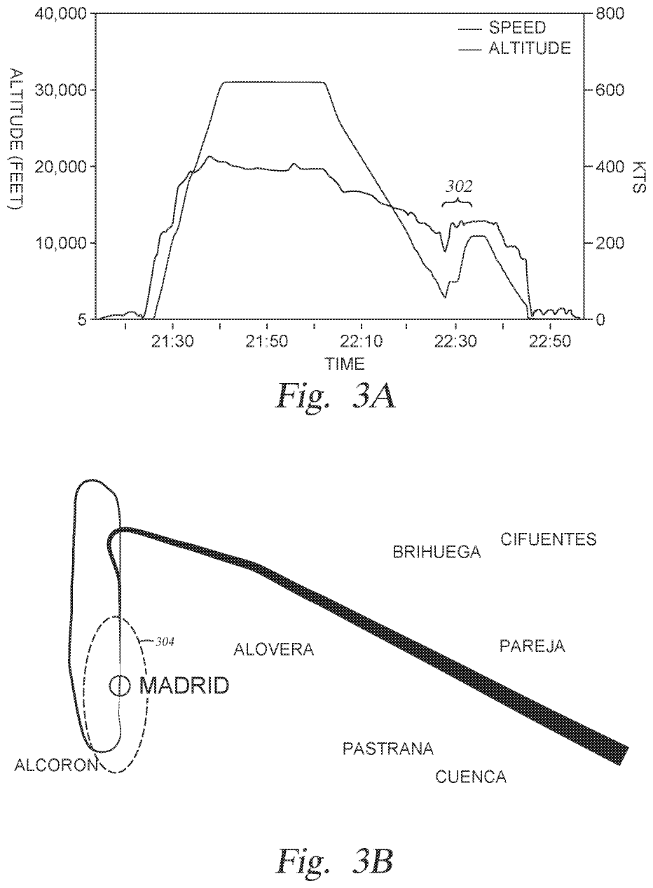

Aspects of the present disclosure provide apparatus and methods for in-flight detection of a maneuver of an aircraft, such as a go-around maneuver. A computer system may analyze in-flight surveillance information to detect a maneuver of an aircraft while the aircraft is flying. As an example, the computer system may detect a maneuver based on a particular pattern in the surveillance information, where the pattern may be indicative of the maneuver occurring. For example, there may be an inflection point in the aircraft trajectory that occurs during a go-around maneuver, as further described herein with respect to FIGS. 3A and 3B. Such an inflection point may be detected using in-flight surveillance information (e.g., in-flight speed and altitude information), airport information (e.g., location and/or altitude information), and various information derived from the surveillance information. The in-flight detection of a maneuver has been tested to detect more than 90% of the go-around events correctly.

The apparatus and methods for in-flight detection of a maneuver described herein may provide various advantages. For example, the apparatus and methods for in-flight detection of a maneuver (such as a go-around maneuver) described herein may allow air traffic controllers (ATCs) to quickly take actions to ensure the safety of the aircraft and its passengers, for example, diverting the flight paths of other aircraft. The in-flight detection of the maneuver described herein may enables ATCs to quickly identify when an aircraft has diverted from planned flight path, adjust other aircraft in the area to avoid potential conflicts, and ensure a minimum delay incurred due to the maneuver. The in-flight detection of the maneuver described herein may allow airport authorities to allocate ground resources such as emergency teams, ground personnel or equipment to prepare for an aircraft's arrival, as well as airlines to reorganize their fleets to mitigate the impact of a delayed flight. Collecting data on the maneuvers may allow aviation authorities and airlines to analyze the root causes and identify areas for improvement in flight operations, training, and air traffic management. The in-flight detection of the maneuver described herein may enable a shared alert on the occurrence of the maneuver among multiple stakeholders (e.g., the ATC, other aircraft, ground crews, flight crews, etc.) in air traffic systems to ensure the respective stakeholders can respond to the maneuver adequately.

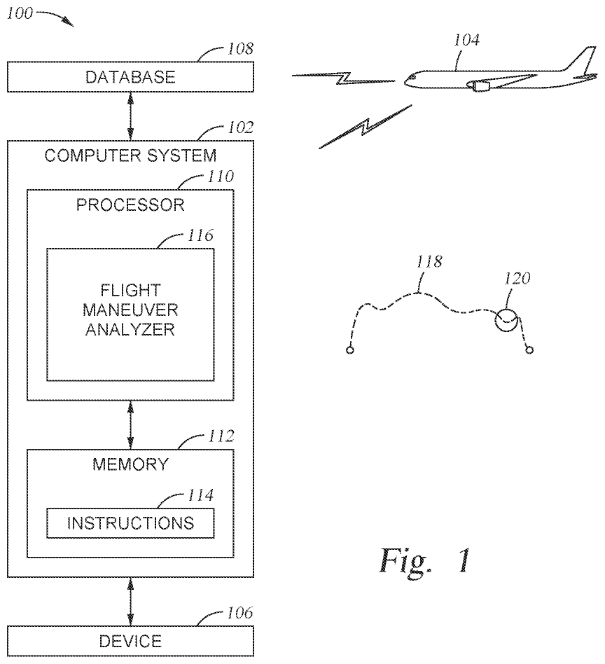

FIG. 1 is a diagram of an example system 100 that monitors in-flight data of an aircraft to detect a maneuver of the aircraft while the aircraft is flying. The system 100 may include a computer system 102. In some aspects, the system 100 may further include an aircraft 104, one or more devices 106 (which may include other aircraft, for example), and/or a database 108.

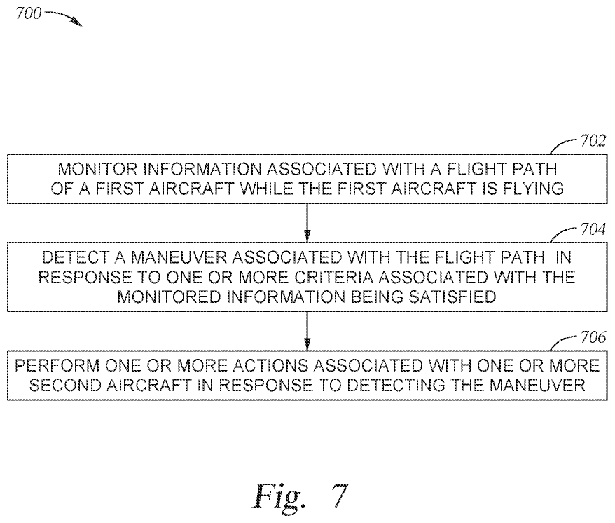

The computer system 102 may be or include a computational device, including for example, a computer, server, desktop computer, laptop computer, tablet computer, smart phone, smart watch or other wearable computer, mainframe computer, quantum computer or any other form of computer or mobile computational device now known or to be developed in the future that is capable of running a program, accessing a network or querying a database, such as the database 108. In certain aspects, a computer-implemented method (for example, as further described herein with respect to FIG. 7) may be performed at the computer system 102 among multiple computers and/or between multiple locations. In some aspects, the computer system 102 may be implemented in a cloud computing environment. The computer system 102 may be in communication with the aircraft 104, the device(s) 106, and/or the database 108.

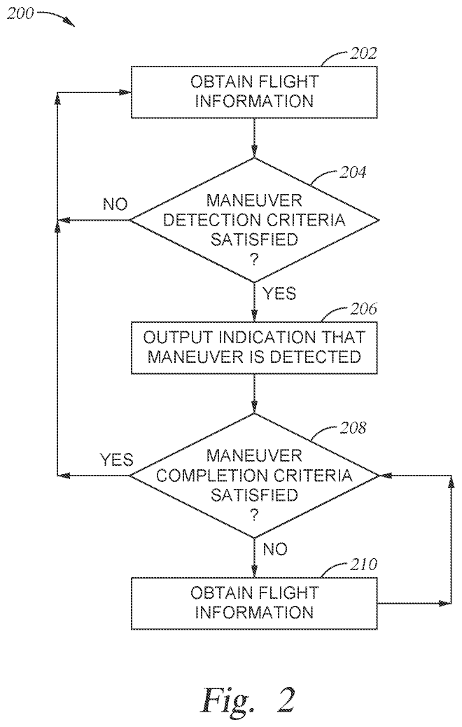

The computer system 102 may include one or more processors, processing blocks or processing elements (collectively “the processor 110”) and one or more memory blocks or elements (collectively “the memory 112”). The processor 110 may be coupled to and/or in communication with the memory 112. The memory 112 includes a computer-readable medium that stores instructions 114 that are executable by the processor 110. The instructions 114 are executable to initiate, perform, or control operations to perform in-flight detection of a maneuver of the aircraft 104 with respect to an executed route of the aircraft 104. The processor 110 may include a flight maneuver analyzer 116 that monitors surveillance information associated with a flight to detect a particular maneuver (e.g., a go-around maneuver), as further described herein with respect to FIG. 2.

The aircraft 104 may be or include a vehicle for traveling through the air, including, for example, an airplane, an unmanned aerial vehicle (UAV), a helicopter, a balloon, etc. In some examples, the computer system 102 is external to the aircraft 104. In other examples, the computer system 102 is integrated in the aircraft 104. The present disclosure may be focused on the aircraft 104 being an airplane and performing in-flight detection of a go-around maneuver to keep the present disclosure as simple as possible. It will be appreciated that the aircraft 104 may be or include any suitable mode of transport, and aspects of the maneuver detection described herein may be applied to monitoring the movement of such modes of transport.

In this example, the aircraft 104 may fly along a flight path 118 in which a particular maneuver 120 in the flight path 118 is detected by the computer system 102 as further described herein. In some cases, the flight path 118 may deviate from a flight plan (e.g., a planned route and/or planned speed), due to any of various factors, such as weather, delays, operational issues with the aircraft, etc. In this example, the aircraft 104 travels the flight path 118 from a first position (e.g., a starting position) to a second position (e.g., an ending position) different from the first position. As shown, the ending position of the flight path 118 is displaced from the starting position of the flight path 118. In some cases, the aircraft 104 may travel the flight path 118 beginning at a particular position and ending at the same position (or effectively the same position, such as the same airport or nearby airport). In certain aspects, the maneuver detection described herein may monitor a portion, a segment, or a phase of the flight path 118, such as one or more phases of a flight. In some aspects, the maneuver detection described herein may monitor any movement(s) associated the aircraft, such as taxiing, takeoff, landing, etc.

The device(s) 106 may be or include an end user device, for example, any computer system, computational device, or computing device that is used and controlled by an end user (e.g., an agent or employee of a fleet operator, an airline employee including, for example, fleet operations personnel, a flight crew, maintenance crew, aircraft technician, etc.). In some examples, the device(s) 106 may include a portable computational device (such as a tablet computer, smart phone, etc.), a ground control device, an electronic flight bag, an airline server, a display device, a communication device, or a combination thereof. To illustrate, the device(s) 106 may include a display device in the aircraft 104 or one or more other aircraft, a fleet control center, an airline control center, air traffic control. The computer system 102 may provide output to the device(s) 106 in response to the maneuver detection described. For example, the computer system 102 may output, to the device(s) 106, an indication of the occurrence of a maneuver via an application programming interface (API). As an example, the computer system 102 may output, to the device(s) 106, an alert associated with the maneuver. The computer system 102 may output the alert associated with the maneuver to one or more other aircraft, air traffic control, airport personnel, aircraft crew, or any combination thereof. In some cases, the alert may trigger air traffic control to adjust one or more flight paths associated with other aircraft. The computer system 102 may adjust a schedule associated with resources (e.g., flight crew, ground crew, and/or fleet) at one or more airports. The computer system 102 may identify a cause associated with the maneuver.

The database 108 may be or include a storage device (or data structure) that stores data associated with the flight path 118 of the aircraft 104. The database 108 may obtain and store the data associated with the flight path 118 for use by other device(s), such as the computer system 102. In certain aspects, the database 108 may provide real-time surveillance information associated with the flight path 118, such as live flight tracking information. In some aspects, the database 108 and data collection may be operated by a service provider, such as FlightRadar24. The database 108 may be in communication with the computer system 102 and/or the aircraft 104. In some examples, the database 108 is external to the computer system 102. In some cases, the database 108 is integrated in the computer system 102. In some examples, the database 108 corresponds to or is included in a server, an external memory, a distributed storage system, or a combination thereof. In some examples, the device(s) 106 are external to the computer system 102, the aircraft 104, or both. In other examples, the device(s) 106 are integrated in the computer system 102, the aircraft 104, or both.

The computer system 102, the aircraft 104, the device(s) 106, and the database 108 are shown as separate from each other as an example. In some cases, any of the computer system 102, the aircraft 104, the device(s) 106, and the database 108 may be integrated as a single device or apparatus. As an example, the computer system 102, the device(s) 106, and/or the database 108 may be integrated as a computer system.

FIG. 2 is a diagram illustrating example operations 200 for performing in-flight detection of a maneuver of an aircraft, such as a go-around maneuver. The operations 200 may be performed by a computer system (e.g., the computer system 102). In certain aspects, the flight maneuver analyzer 116 of the computer system 102 may perform any of the aspects associated with the operations 200. The operations 200 may be implemented as software components (e.g., the computer-readable instructions 114) that are executed on one or more processors (e.g., the processor 110) of an apparatus (e.g., the computer system 102) to cause the apparatus to perform any aspect of the operations 200.

At block 202, the computer system may obtain flight information associated with a flight path (e.g., the flight path 118) of an aircraft (e.g., the aircraft 104). The computer system may obtain the flight information while the aircraft is flying, for example, via an ADS-B system. The flight information may be or include information associated with a segment of the flight of the aircraft, such as surveillance information associated with a particular duration (e.g., 500 milliseconds, 30 seconds, 60 seconds, etc.). The computer system may retrieve the flight information from the database 108 and/or receive the flight data from the aircraft. The flight information may include data generated by sensors and/or instruments of the aircraft during various phases of the flight. In certain aspects, the flight information may include data generated via a quick access recorder (QAR) of an aircraft. For example, the flight information may include one or more entries indicating various information associated with the flight, including, for example, time, pressure altitude, altitude (Hp), flight path angle (γ), air temperature (T), Mach number (M) (e.g., including the commanded Mach), aircraft mass (m), fuel flow (FF), aircraft gross weight, airspeed, ground speed, wind speed, wind direction, heading, course, normal acceleration, longitudinal acceleration, lateral acceleration, pitch trim position, angle of attack, pitch attitude, roll attitude, radio transmission keying, power on each engine, thrust reverser position, auto pilot engagement status, latitude, longitude, one or more other parameters associated with the flight, or a combination thereof. In some cases, the flight information may be derived from one or more sensor readings or measurements.

At block 204, the computer system may determine whether one or more maneuver detection criteria are satisfied based on the flight information obtained at block 202. For example, the computer system may evaluate if a pattern in the flight information is indicative of the maneuver. The computer system may identify if a particular inflection point (e.g., a trough) indicative of a go-around maneuver is occurring in the flight information, for example, as depicted in FIG. 3A.

The detection criteria may include, for example, when a distance to the destination is less than (or equal to) 7,500 to 22,500 meters (e.g., 15,000 meters); when an altitude change (within a specified time period, such as 1 seconds, 30 seconds, or 60 seconds) is greater than (or equal to) 25 to 75 feet (e.g., 50 feet), when a vertical speed is greater than (or equal to) 500 to 1,500 feet per minute (e.g., 1,000 feet per minute), when a height above a destination is greater than (or equal to) 1,000 to 3,000 feet (e.g., 2,000 feet), when a speed is greater than (or equal to) 45 to 135 knots (e.g., 90 knots), when a cumulated distance traveled is greater than (or equal to) 12,500 to 37,500 meters (e.g., 25,000 meters), or any combination thereof. Such criteria are examples, and any of the threshold values may be configured to adjust the sensitivity of the maneuver detection. Those of skill in the art will understand that the parameters for the criteria are examples (e.g., distance to the destination, altitude change, height above the destination, speed, and/or cumulated distance traveled). Other parameters or categories of parameters may be used in addition to or instead of those described.

In response to the maneuver detection criteria not being satisfied, the computer system may continue to obtain flight information at block 202. The computer system may periodically check if the maneuver detection criteria are satisfied, for example, every 500 milliseconds, 30 seconds, 60 seconds, etc., based on the most recent flight information obtained at block 202.

At block 206, in response to the maneuver detection criteria being satisfied, the computer system may output an indication that the maneuver is detected. The computer system may send an alert that the maneuver is detected to the one or more devices 106. As an example, the computer system may alert one or more airlines, other aircraft, air traffic control, airport personnel, aircraft crew, or any combination thereof. Alerting other aircraft may prepare the crew of the other aircraft to determine if a similar maneuver is expected to be made by the other aircraft, for example, due to weather, delays, etc.

At block 208, the computer system may determine whether one or more maneuver completion criteria are satisfied. In response to the maneuver completion criteria being satisfied, the computer system may continue to monitor for other maneuver(s) and/or other flight phase(s). As an example, the computer system may return to monitoring the flight surveillance information in order to detect a subsequent maneuver, if any. In some cases, the computer system may apply a time-based completion determination. For example, the computer system may consider the maneuver to be completed when a certain time period (e.g., 90 to 270 seconds) has elapsed since the start time associated with the detected maneuver. In some cases, the go-around maneuver may be considered to be complete after 180 seconds have elapsed since the maneuver's detection. Defining the end of the go-around maneuver may allow the computer system to detect other flight events, such as a subsequent go-around maneuver, a new landing attempt, or climb to divert to a different airport. In certain cases, the computer system may apply a position-based completion determination. For example, the computer system may determine if the go-around maneuver is complete based on how close the aircraft is to the destination.

In response to the maneuver completion criteria not being satisfied, the computer system may continue to obtain flight information at block 210. The computer system may periodically check if the maneuver completion criteria are satisfied, for example, every 500 milliseconds, 30 seconds, 60 seconds, etc., based on the most recent flight information obtained at block 210.

FIGS. 3A and 3B illustrate an example speed and altitude graph over time and a flight path associated with a flight in which a go-around maneuver is detected as described herein. In this example, the aircraft may perform a go-around maneuver as indicated in a first segment 302 of the vertical profile in FIG. 3A and second segment 304 of the flight path in FIG. 3B. Referring to FIG. 3A, the go-around maneuver at segment 302 exhibits a trough in the altitude, where the aircraft changes from a descent to an ascent.

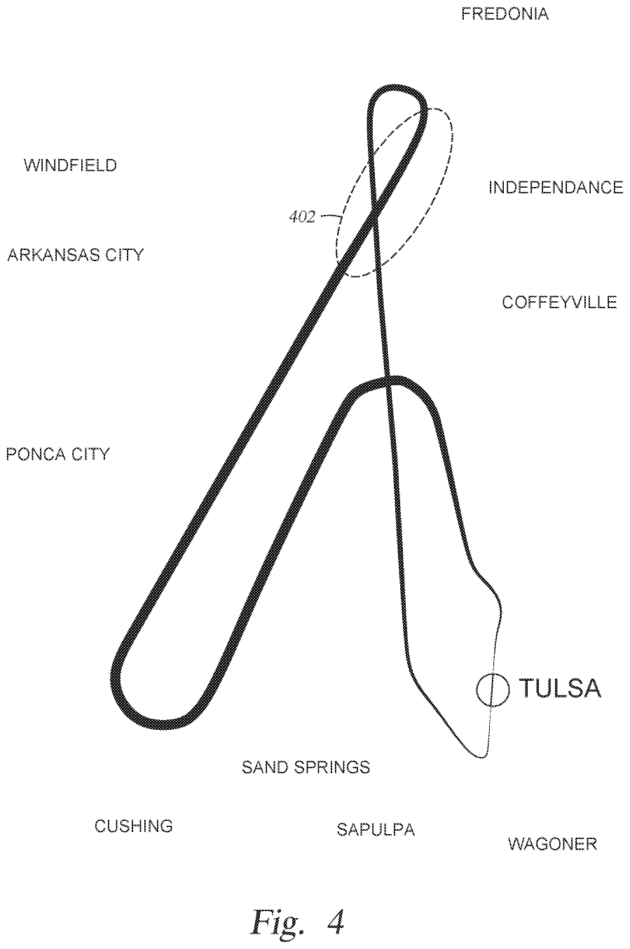

In some cases, the aircraft may depart from and arrive at the same airport or at adjacent airports (e.g., John F. Kennedy International Airport and LaGuardia Airport). Using a threshold for cumulated distance traveled facilitates the detection of a go-around maneuver in such cases. FIG. 4 illustrates an example go-around maneuver 402 being detected when an aircraft departs from and arrives at the same airport. Without the threshold for the cumulated distance traveled, a go-around maneuver may be detected immediately after take-off.

Regarding the aircraft vertical position, flight surveillance information (e.g., live flight tracking information via ADS-B) may offer two options: altitude (above mean sea level) and height above destination. An altitude threshold may lead to wrong results for detecting certain maneuvers for airports located at high altitudes, such as Denver.

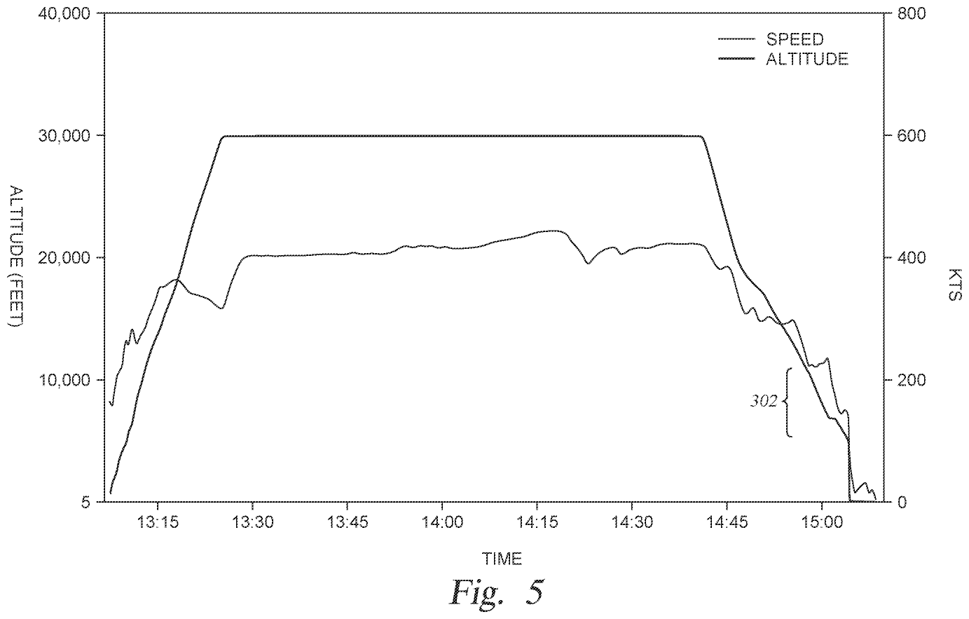

FIG. 5 illustrates a speed and altitude graph over time of an example flight from Shreveport to Denver, where the height above the destination is used to detect a go-around maneuver. Right before the landing, the aircraft was reporting an altitude of 5,000 feet, well above a 2,000-feet altitude threshold set in a flight maneuver analyzer. Thus, the computer system would not detect a go-around maneuver using such an altitude threshold, whereas a threshold 502 for the height above the destination may facilitate a detection of a go-around maneuver where the destination may be located at a high altitude, such as Denver.

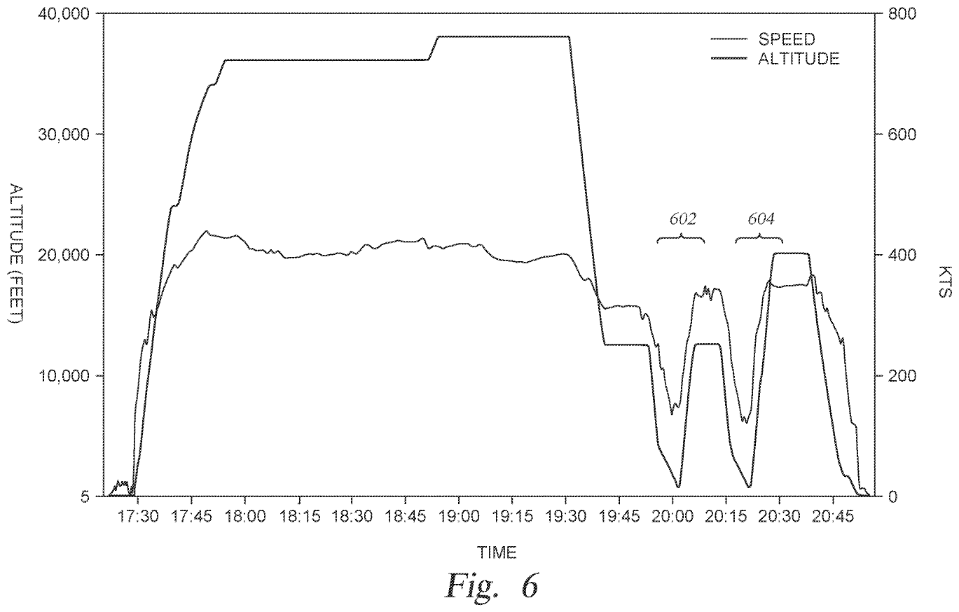

FIG. 6 illustrates an example speed and altitude graph over time where multiple go-around maneuvers 602, 604 are detected. Adjusting the duration of the go-around maneuver (e.g., the elapsed time to consider the go-around maneuver complete) may facilitate detection of go-around maneuvers performed in succession, such as for test flights. In some cases, a duration of five minutes may be able to detect some go-around maneuvers that occur in quick succession, for example, where an aircraft manufacturer and/or airline is testing an aircraft. A three minute duration threshold may be able to detect go-around maneuvers that occur close together in time and prevent certain go-around maneuver from being missed.

FIG. 7 is a method flow diagram illustrating example operations 700 for in-flight detection of a maneuver of an aircraft. The operations 700 may be performed, for example, by a computer system (e.g., the computer system 102 as depicted in FIG. 1) and/or a fleet operator (e.g., an airline).

The operations 700 may optionally begin, at block 702, where the computer system may monitor information associated with a flight path (e.g., the flight path 118) of a first aircraft (e.g., the aircraft 104) while the first aircraft is flying. In certain aspects, the information may include flight surveillance information, for example, tracked via a network of ADS-B devices.

At block 704, the computer system may detect a maneuver (e.g., the maneuver 120) associated with the flight path in response to one or more criteria associated with the monitored information being satisfied. In certain aspects, the maneuver may include a go-around maneuver, for example, as described herein with respect to FIGS. 3A and 3B. The one or more criteria may be designed to detect a specific pattern in the information. For example, a trough (or at least the ascent in the trough) in the vertical profile of a flight path may be indicative of a go-around maneuver.

At block 706, the computer system may perform one or more actions (while the first aircraft is flying) associated with a second aircraft (e.g., the device(s) 106) in response to detecting the maneuver. For example, the computer system may indicate to an end user device (e.g., the device 106) to perform any of various actions. To perform the action(s), the computer system may output an indication of the maneuver via an API to a computing device (e.g., the device 106). In some aspects, the computer system may output an alert associated with the maneuver to the computing device. In certain cases, the computer system may output the alert associated with the maneuver to the second aircraft, air traffic control, airport personnel, aircraft crew, or any combination thereof. The computer system may adjust one or more flight paths associated with the aircraft, for example, to avoid any conflicts with the first aircraft performing the maneuver. The computer system may adjust a schedule associated with one or more resources (e.g., flight crew, ground crew, airport personnel, and/or fleet) at one or more airports. In some cases, the computer system may identify a cause associated with the maneuver, for example, due to weather, delays, airport congestion, etc.

In certain aspects, the maneuver detection criteria may be or include any of the criteria described herein with respect to FIG. 2. For example, the criteria may include a first criterion associated with a distance to a destination of the flight path; a second criterion associated with an altitude change of the first aircraft; a third criterion associated with a vertical speed of the first aircraft; a fourth criterion associated with a height above the destination of the first aircraft; a fifth criterion associated with a speed of the first aircraft; a sixth criterion associated with a cumulated distance traveled by the first aircraft; or a combination thereof. The first criterion may be satisfied when the distance to the destination is less than or equal to a first threshold. The second criterion may be satisfied when the altitude change is greater than or equal to a second threshold. The third criterion may be satisfied when the vertical speed is greater than or equal to a third threshold. The fourth criterion may be satisfied when the height above the destination is less than or equal to a fourth threshold. The fifth criterion may be satisfied when the speed is greater than a fifth threshold. The sixth criterion may be satisfied when the cumulated distance traveled is greater than or equal to a sixth threshold. The first threshold may include a first value of 7,500 to 22,500 meters. The second threshold may include a second value of 25 to 75 feet. The third threshold may include a third value of 500 to 1,500 feet per minute. The fourth threshold may include a fourth value of 1,000 to 3,000 feet. The fifth threshold may include a fifth value of 45 to 135 knots. The sixth threshold may include a sixth value of 12,500 to 37,500 meters.

For certain aspects, the computer system may detect when the maneuver is completed. For example, the computer system may detect when the maneuver is completed based at least in part on a specified duration (e.g., 180 seconds) elapsing after a start time associated with the maneuver. In some cases, the computer system may detect when the maneuver is completed based at least in part on a position associated with the first aircraft.

The in-flight surveillance information monitored by the computer system may include any of various information. In some cases, the information comprises one or more time-series including: pressure information, altitude information, speed information, fuel flow information, gross weight information, wind speed information, wind direction information, total air temperature information, Mach number information, heading information, course information, time information, latitude information, longitude information, or a combination thereof.

It will be appreciated that the apparatus and methods for in-flight detection of a maneuver may provide various advantages. The automated in-flight detection described herein may enable air traffic control, the flight crew of other aircraft, and/or airport personnel to perform various actions in response to the detected maneuver. For example, the air traffic control may adjust the flight path of other aircraft in response to a go-around being detected to avoid any conflicts among the aircraft.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method, comprising:
monitoring information associated with a flight path of a first aircraft while the first aircraft is flying;
detecting a maneuver associated with the flight path in response to one or more criteria associated with the monitored information being satisfied; and
performing one or more actions associated with a second aircraft in response to detecting the maneuver.

2. The method of claim 1, wherein the maneuver comprises a go-around maneuver.

3. The method of claim 1, wherein the one or more criteria comprises:
a first criterion associated with a distance to a destination of the flight path;
a second criterion associated with an altitude change;
a third criterion associated with a vertical speed;
a fourth criterion associated with a height above the destination;
a fifth criterion associated with a speed;
a sixth criterion associated with a cumulated distance; or
a combination thereof.

4. The method of claim 3, wherein:
the first criterion is satisfied when the distance to the destination is less than a first threshold;
the second criterion is satisfied when the altitude change is greater than a second threshold;
the third criterion is satisfied when the vertical speed is greater than a third threshold;
the fourth criterion is satisfied when the height above the destination is less than a fourth threshold;
the fifth criterion is satisfied when speed is greater than a fifth threshold; and
the sixth criterion is satisfied when the cumulated distance is greater than a sixth threshold.

5. The method of claim 4, wherein:
the first threshold includes a first value of 7,500 to 22,500 meters;
the second threshold includes a second value of 25 to 75 feet;
the third threshold includes a third value of 500 to 1,500 feet per minute;
the fourth threshold includes a fourth value of 1,000 to 3,000 feet;
the fifth threshold includes a fifth value of 45 to 135 knots; and
the sixth threshold includes a sixth value of 12,500 to 37,500 meters.

6. The method of claim 1, further comprising detecting when the maneuver is completed based at least in part on a specified duration elapsing after a start time associated with the maneuver.

7. The method of claim 1, further comprising detecting when the maneuver is completed based at least in part on a position associated with the first aircraft.

8. The method of claim 1, wherein the information comprises one or more time-series including: pressure information, altitude information, speed information, fuel flow information, gross weight information, wind speed information, wind direction information, total air temperature information, Mach number information, heading information, course information, time information, latitude information, longitude information, or a combination thereof.

9. The method of claim 1, wherein performing the one or more actions comprises:
outputting an indication of the maneuver via an application programming interface (API) to a computing device;
outputting an alert associated with the maneuver to the computing device;
outputting the alert associated with the maneuver to the second aircraft, air traffic control, airport personnel, aircraft crew, or any combination thereof;
adjusting one or more flight paths associated with the second aircraft;
adjusting a schedule associated with one or more resources at one or more airports;
identifying a cause associated with the maneuver; or
a combination thereof.

10. An apparatus, comprising:
a memory; and
one or more processors coupled to the memory, the one or more processors being configured to:
monitor information associated with a flight path of a first aircraft while the first aircraft is flying,
detect a maneuver associated with the flight path in response to one or more criteria associated with the monitored information being satisfied, and
perform one or more actions associated with one more second aircraft in response to detecting the maneuver.

11. The apparatus of claim 10, wherein the maneuver comprises a go-around maneuver.

12. The apparatus of claim 10, wherein the one or more criteria comprises:
a first criterion associated with a distance to a destination of the flight path;
a second criterion associated with an altitude change;
a third criterion associated with a vertical speed;
a fourth criterion associated with a height above the destination;
a fifth criterion associated with a speed;
a sixth criterion associated with a cumulated distance traveled by the first aircraft; or
a combination thereof.

13. The apparatus of claim 12, wherein:
the first criterion is satisfied when the distance to the destination is less than a first threshold;
the second criterion is satisfied when the altitude change is greater than a second threshold;
the third criterion is satisfied when the vertical speed is greater than a third threshold;
the fourth criterion is satisfied when the height above the destination is less than a fourth threshold;
the fifth criterion is satisfied when the speed is greater than a fifth threshold; and
the sixth criterion is satisfied when the cumulated distance is greater than a sixth threshold.

14. The apparatus of claim 13, wherein:
the first threshold includes a first value of 7,500 to 22,500 meters;
the second threshold includes a second value of 25 to 75 feet;
the third threshold includes a third value of 500 to 1,500 feet per minute;
the fourth threshold includes a fourth value of 1,000 to 3,000 feet;
the fifth threshold includes a fifth value of 45 to 135 knots; and
the sixth threshold includes a sixth value of 12,500 to 37,500 meters.

15. The apparatus of claim 10, wherein the one or more processors are further configured to detect when the maneuver is completed based at least in part on a specified duration elapsing after a start time associated with the maneuver.

16. The apparatus of claim 10, wherein the one or more processors are further configured to detect when the maneuver is completed based at least in part on a position associated with the first aircraft.

17. The apparatus of claim 10, wherein the information comprises one or more time-series including: pressure information, altitude information, speed information, fuel flow information, gross weight information, wind speed information, wind direction information, total air temperature information, Mach number information, heading information, course information, time information, latitude information, longitude information, or a combination thereof.

18. The apparatus of claim 10, wherein to perform the one or more actions, the one or more processors are configured to:
output an indication of the maneuver via an application programming interface (API) to a computing device;
output an alert associated with the maneuver to the computing device;
outputting the alert associated with the maneuver to the second aircraft, air traffic control, airport personnel, aircraft crew, or any combination thereof;
adjust one or more flight paths associated with the second aircraft;
adjust a schedule associated with one or more resources at one or more airports;
identify a cause associated with the maneuver; or
a combination thereof.

19. A non-transitory computer-readable medium storing code that, when executed by one or more processors of an apparatus, cause the apparatus to perform a method, the method comprising:
monitoring information associated with a flight path of a first aircraft while the first aircraft is flying;
detecting a maneuver associated with the flight path in response to one or more criteria associated with the monitored information being satisfied; and
performing one or more actions associated with one more second aircraft in response to detecting the maneuver.

20. The non-transitory computer-readable medium of claim 19, wherein the one or more criteria comprises:
a first criterion associated with a distance to a destination associated with the flight path;
a second criterion associated with an altitude change;
a third criterion associated with a vertical speed;
a fourth criterion associated with a height above the destination;
a fifth criterion associated with a speed;
a sixth criterion associated with a cumulated distance; or
a combination thereof.
